(19) United States
(12) Patent Application Publication
(10) Pub. No.: US 2009/0006235 A1
(43) Pub. Date: Jan. 1, 2009

(54) PROCESSING CONTINGENT PAYMENTS

(75) Inventor: John Peter Connolly, Teddington (GB)

Correspondence Address: MOLLBORN PATENTS, INC., 2840 COLBY DRIVE, BOULDER, CO, 80305, US

(73) Assignee: Wigadoo Limited, London (GB)

(21) Appl. No.: 12/123,928

(22) Filed: May 20, 2008

Related U.S. Application Data
(60) Provisional application No. 60/947,067, filed on Jun. 29, 2007.

(51) Int. Cl. G06Q 20/00; G06Q 50/00

(52) U.S. Cl. 705/35

(57) ABSTRACT

Methods and apparatus, including computer program products, implementing and using techniques for granting authorization to conduct a monetary transfer. A proposal is created. The proposal specifies one or more named third parties, one or more specified actions, and a time frame in which the one or more specified actions is to be completed. The proposal is distributed to the one or more named third parties. Each of the one or more named third parties completes the specified actions within the time frame specified in the proposal. Authorization to process the monetary transfer is given in response to the one or more specified actions being completed by the one or more named third parties.

### CROSS-REFERENCE TO RELATED APPLICATIONS

The present application claims priority under 35 U.S.C. 119(e) from U.S. Provisional Patent Application No. 60/947,067 entitled “PROCESSING CONTINGENT PAYMENTS” filed 29 Jun. 2007, the entire disclosure of which is incorporated herein by reference for all purposes.

### BACKGROUND

This invention relates to the field of electronic commerce. Most systems for processing the sale of products are seller-driven, that is, the seller prices, packages, configures and offers the product for sale, and the buyer decides whether or not to accept the seller's offer. In a buyer-driven system, however, the buyer specifies the terms of an offer and one or more sellers decide whether or not to accept the offer. A “help wanted” advertisement can be considered an example of a buyer-driven inquiry, since the employer is looking to buy the services of a qualified employee. The inquiry is advertised to a large number of potential employees, who may respond by submitting their resumes to the prospective employer.

Another type of sale situation is a situation in which a buyer's decision to purchase a product is contingent on other people's decisions, that is, an “I'm in if you're in” or “I will if you will” situation. Some examples of such situations include buying vacations or purchasing dance class lessons. Current systems cannot handle contingent purchases or payments in any efficient manner. Thus, there is a need for systems and methods for processing contingent payments.

### SUMMARY

In general, in one aspect, the invention provides methods and apparatus, including computer program products, implementing and using techniques for granting authorization to conduct a monetary transfer. A proposal is created. The proposal specifies one or more named third parties, one or more specified actions, and a time frame in which the one or more specified actions is to be completed. The proposal is distributed to the one or more named third parties. Each of the one or more named third parties completes the specified actions within the time frame specified in the proposal. Authorization to process the monetary transfer is given in response to the one or more specified actions being completed by the one or more named third parties.

Various embodiments of the can include one or more of the following features. The monetary transfer can be a card payment or an electronic fund transfer. The distributing, completing and granting operations can be performed using secure transactions on a computer network. The computer network can be the Internet or an intranet. Each of the one or more named third parties can be identified by a username, or an email address. The one or more specified actions can include directly granting an authorization to process a monetary transfer, or indirectly granting an authorization to process a monetary transfer. The authorization to process a monetary transfer can relate to instances of a same product or service as the initial contingent authorization. The instances of the product or service purchased by all parties can be delivered at the same time and place. The purpose of specifying the one or more actions in the proposal can be to ensure co-participation in buying instances of a product or service. The instances of the product or service can relate to the leisure and/or travel sectors. Granting authorization can include granting authorization to a third party agent acting on behalf of the entity ultimately fulfilling the product or service being purchased by the authorizing party.

Various embodiments of the invention can be implemented to include one or more of the following advantages over existing technologies. The barriers to purchase initiation are reduced. Unwanted purchases can be removed. The communication requirement between parties in a purchasing transaction is reduced. The uncertainty regarding people's intentions can be removed. The buyer interest is made visible to the merchants in advance to the final purchase.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a process for managing contingent payment in accordance with one embodiment of the invention.

FIG. 2 is a schematic diagram showing an implementation of the process of FIG. 1 in accordance with one embodiment of the invention.

FIG. 3 is a schematic diagram showing an alternative implementation of the process of FIG. 1 in accordance with another embodiment of the invention.

Like reference symbols in the various drawings indicate like elements.

### DETAILED DESCRIPTION

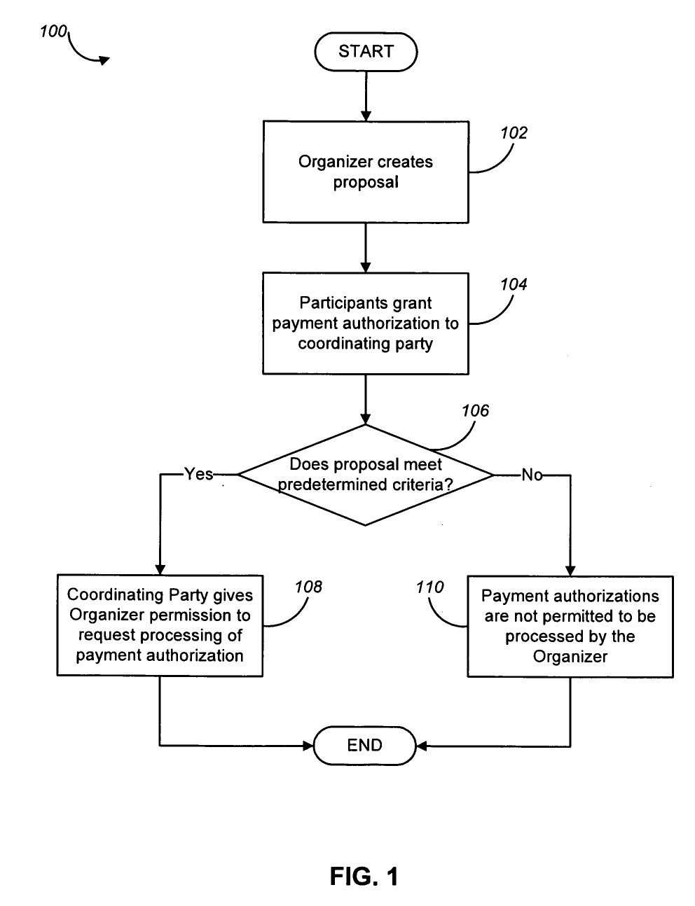

As shown in FIG. 1, a process (100) for managing contingent payments in accordance with one embodiment of the invention starts by a Proposal being created (step 102). In some embodiments the Proposal is created by an individual, referred to herein as an Organizer. The Proposal declares the Organizer's intention for the use of specific funds, for example, renting a vacation home together or buying a set of theater tickets for adjacent seats, and so on. In some embodiments, the Proposal can be implemented as a web page, which specifies the details of the proposal and the Organizer's intentions. The web page can then be distributed to a set of individuals, referred to herein as Participants, selected by the Organizer. The distribution of the web page can be made, for example, by way of an email that includes a link to the web page with the proposal. Depending on the implementation, the funds can either be received by the Organizer, or be directed to a third party.

Next, the Participants pledge support to the Proposal by granting a payment authorization to a Coordinating Party (step 104). For example, the participant can click a “Count me in” button or similar on the Proposal and supply their credit/debit card details, or they can click an “I'm in if you're in” button or similar on the Proposal and supply their credit/debit card details. As the skilled person realizes, this can be implemented in a variety of ways, such as buttons, forms, checkboxes, and so on, just to mention a few.

The process then determines whether the Proposal achieves certain pre-determined criteria (step 106). These pre-determined criteria are specified up-front by the Organizer. They can include, for example, needing a certain number of people to sign up, that certain named participants must sign up, and so on. Typically, the Organizer also specifies a time in the Proposal, by which the Participants must sign up for the criteria to be met. If the Proposal achieves the pre-determined criteria, then the Coordinating Party gives the Organizer permission to request processing of the payment authorization (for the benefit of the assigned party) (step 108), and the process ends. It should be noted that in some implementations, the request can be made automatically on behalf of the Organizer (by the Coordinating Party) if certain pre-agreed criteria are met, such as a particular set of named parties have given permission or signed up. If it is determined in step 106 that the pre-determined criteria are not met, the payment authorizations are not permitted to be processed by the Organizer (step 110), and the process ends.

It should be noted that in some embodiments, the Participants can optionally specify additional criteria, above and beyond those specified by the Organizer, which are evaluated in step (106). This specification of additional criteria can be thought of as an “I'm in if you're in” function. In these embodiments, a Participant can make their payment authorization contingent on a third party, named by the Participant. Using the above example of buying theater tickets, the Organizer can for example specify that the tickets should be bought if at least 8 people agree to attend the show. Then, in addition, a participant may specify that he will only go to the show if his girlfriend also agrees to go to the show, for example.

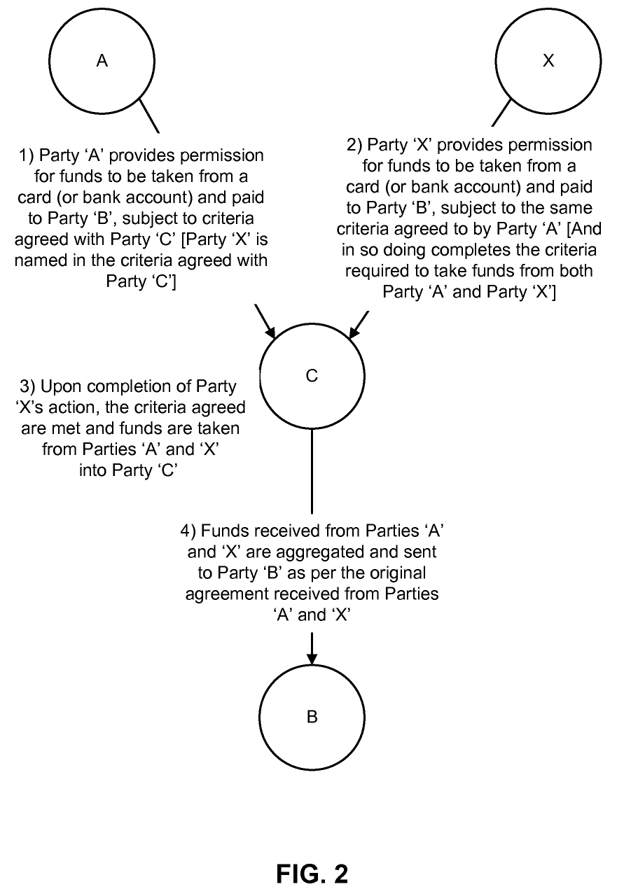

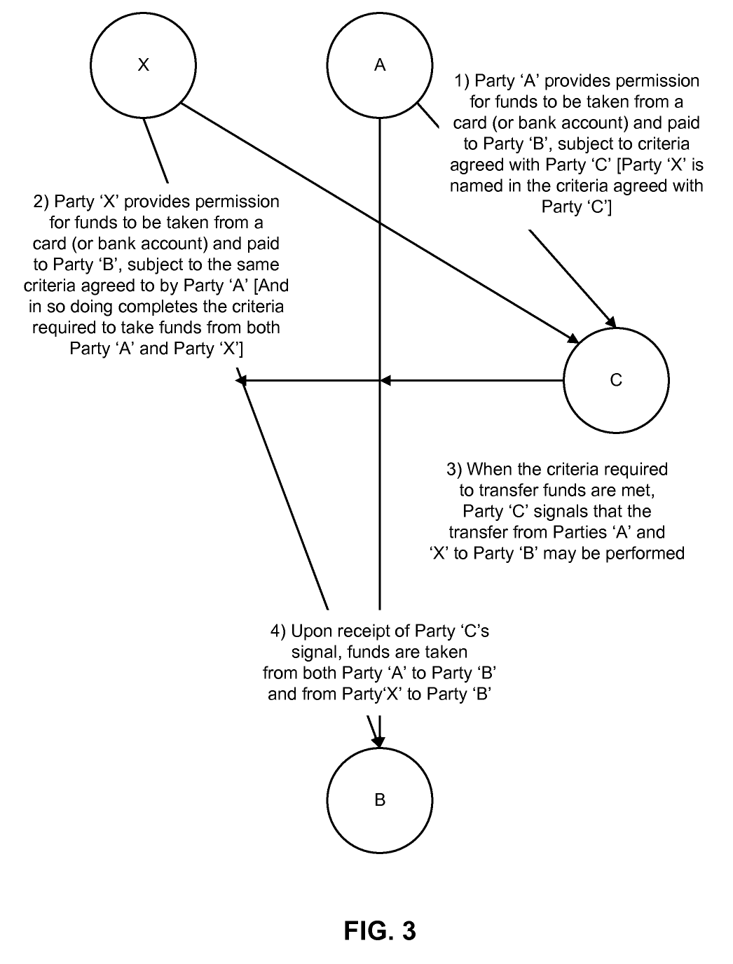

As was described above, the process (100) of FIG. 1 can be referred to as an “I'm in if you're in”-process or “I will if you will”-process. The process can be implemented in a number of ways. Two exemplary conceptual implementation choices will be described below with reference to FIGS. 2 and 3. In the first exemplary implementation choice, which is illustrated in FIG. 2, funds are routed through the same entity that controls the authorities to have funds moved. In the second exemplary implementation choice, which is illustrated in FIG. 3, funds are routed through a different entity to the entity that controls the authorities to have funds moved. Each of these exemplary implementations will now be described.

As can be seen in FIG. 2, a Party ‘A’ provides permission for funds to be taken from a credit card or bank account and to be paid to a Party ‘B,’ subject to criteria agreed upon with a Party ‘C.’ A Party ‘X’ is mentioned in the criteria agreed upon with Party ‘C.’ Party ‘C’ can be, for example, the holder or an Internet Merchant Account (IMA), and Party ‘B’ can be, for example, an individual, merchant or a stored value card.

The permissions received from Parties ‘A’ and ‘X’ can be, for example, credit/debit card pre-authorizations, authorizations to withdraw money from a bank account (sometimes also known as Direct Debit Mandates), or (more simply) validated card details. In addition to the pre-authorizations captured, Party ‘C’ agrees not to authorize the transaction until all the criteria agreed to by the parties have been met. Specifically, Party ‘A’ would agree to have funds transferred if and only if Party ‘X’ agrees to do the same.

Next, Party ‘X’ provides permission for funds to be taken from a credit card (or bank account) and to paid to Party ‘B,’ subjected to the same criteria agreed to by Party ‘A.’ That is, Party ‘X’ agrees to have funds transferred if and only if Party ‘A’ is bound to do the same once Party ‘X’ agrees. In doing so, Party ‘X’ completes the criteria required to take funds from both Party ‘A’ and Party ‘X.’

Upon completion of Party ‘X’s action, the criteria agreed are met and funds are transferred from Parties ‘A’ and ‘X’ into Party ‘C.’s IMA. If funds from both ‘A’ and ‘X’ are successfully acquired, the funds are aggregated and transferred to Party ‘B,’ as per the original agreement received from parties ‘A’ and ‘X.’ If for some reason the funds are not successfully acquired from either Party ‘A’ or ‘X’ any successful transfer from either parties ‘A’ or ‘X’ is reversed.

The second implementation, shown in FIG. 3, is similar to the implementation shown in FIG. 2, except that Party ‘C’ is not required to process funds. Instead, in this implementation, the permissions received from Parties ‘A’ and ‘X’ can contain, for example:
a) the right to provide card/account details to Party ‘B’ in order to execute a ‘pull’ of funds from the parties to ‘B’ (under the same permission that was granted to Party ‘C.’);
b) the right to provide card/account details to a funds transfer service provider in order to execute a transfer of funds from the Parties ‘A’ and ‘X’ to ‘B’. The funds transfer service provider can be, for example, a person-to-person, card-to-card or account-to-account service provider;
c) a pre-authorization either granted to Party ‘B’ directly (but subject to processing constraints as per the agreement with Party ‘C.’) or a pre-authorization granted to a funds transfer service provider in order to execute a transfer of funds from the Parties ‘A’ and ‘X’ to ‘B’. The funds transfer service provider can be, for example, a person-to-person, card-to-card or account-to-account service provider;
d) card/account details either provided to Party ‘B’ directly (but subject to processing constraints as per the agreement with Party ‘C.’) or a card/account details granted to a funds transfer service provider in order to execute a transfer of funds from the Parties ‘A’ and ‘X’ to ‘B’. The funds transfer service provider can be, for example, be a person-to-person, card-to-card or account-to-account service provider.

As can be seen in FIG. 3, steps 1 and 2 are similar to steps 1 and 2 of FIG. 2. However, in the implementation shown in FIG. 3, when the criteria required to transfer funds are met, Party ‘C’ signals that the transfer from Parties ‘A’ and ‘X’ to Party ‘B’ can be performed. Upon receipt of Party ‘C.’s signal, funds are transferred from Party ‘A’ to Party ‘B’ and from Party ‘X’ to Party ‘B.’

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user. The user can provide input to the computer system through various input devices such as a keyboard and a pointing device, such as a mouse, a trackball, a microphone, a touch-sensitive display, a transducer card reader, a magnetic or paper tape reader, a tablet, a stylus, a voice or handwriting recognizer, or any other well-known input device such as, of course, other computers. The computer system can be programmed to provide a graphical user interface through which computer programs interact with users.

Finally, the processor optionally can be coupled to a computer or telecommunications network, for example, an Internet network, or an intranet network, using a network connection, through which the processor can receive information from the network, or might output information to the network in the course of performing the above-described method steps. Such information, which is often represented as a sequence of instructions to be executed using the processor, may be received from and outputted to the network, for example, in the form of a computer data signal embodied in a carrier wave. The above-described devices and materials will be familiar to those of skill in the computer hardware and software arts.

It should be noted that the present invention employs various computer-implemented operations involving data stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms, such as, producing, identifying, running, determining, comparing, executing, downloading, or detecting. It is sometimes convenient, principally for reasons of common usage, to refer to these electrical or magnetic signals as bits, values, elements, variables, characters, data, or the like. It should remembered however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general-purpose computer selectively activated or configured by a computer program stored in the computer. The processes presented above are not inherently related to any particular computer or other computing apparatus. In particular, various general-purpose computers may be used with programs written in accordance with the teachings herein, or, alternatively, it may be more convenient to construct a more specialized computer system to perform the required operations.

A number of implementations of the invention have been described. Nevertheless, it will be understood that various modifications may be made without departing from the spirit and scope of the invention. For example, the various embodiments above have been described in the context of monetary transfers, but it is also possible to apply the same concepts to general permissions for performing actions or tasks in an online environment. For example, a party A may only be able to perform certain actions (e.g. viewing a document or accessing a particular database, and so on) if and only if permission has been received from party X, or if party X is concurrently monitoring the activities of party A. Time limits can also be set on the actions or permissions. In another aspect of the invention, changes can be made dynamically to existing Proposals and Permissions. For example, the amount of money processed from an original Permission can be altered downwards based on the number of people participating, which allows for “group discounts” and so on to be processed. Accordingly, other embodiments are within the scope of the following claims.

1. A computer-implemented method for granting authorization to conduct a monetary transfer, the method comprising:
creating a proposal, the proposal specifying one or more named third parties, one or more specified actions, and a time frame in which the one or more specified actions is to be completed;
distributing the proposal to the one or more named third parties;
completing the one or more specified actions by each of the one or more named third parties within the time frame specified in the proposal; and
granting authorization to process the monetary transfer in response to the one or more specified actions being completed by the one or more named third parties.

2. The method of claim 1, wherein the monetary transfer is one of: a card payment and an electronic fund transfer.

3. The method of claim 1, wherein the distributing, completing and granting operations are performed using secure transactions on a computer network.

4. The method of claim 3, wherein the computer network is one of: the Internet and an intranet.

5. The method of claim 1, wherein each of the one or more named third parties is identified by one of: a username, and an email address.

6. The method of claim 1, wherein the one or more specified actions include one of: directly granting an authorization to process a monetary transfer, and indirectly granting an authorization to process a monetary transfer.

7. The method of claim 6, wherein the authorization to process a monetary transfer relates to instances of a same product or service as the initial contingent authorization

8. The method of claim 7, wherein the instances of the product or service purchased by all parties is to be delivered at the same time and place.

9. The method of claim 1, wherein the purpose of specifying the one or more actions in the proposal is to ensure co-participation in buying instances of a product or service.

10. The method of claim 7, wherein the instances of the product or service relate to the leisure and/or travel sectors.

11. The method of claim 1, wherein granting authorization includes granting authorization to a third party agent acting on behalf of the entity ultimately fulfilling the product or service being purchased by the authorizing party.

12. A computer program product, stored on a machine-readable medium, for granting authorization to conduct a monetary transfer, comprising instructions operable to cause a computer to:
create a proposal, the proposal specifying one or more named third parties, one or more specified actions, and a time frame in which the one or more specified actions is to be completed;
distribute the proposal to the one or more named third parties;
complete the one or more specified actions by each of the one or more named third parties within the time frame specified in the proposal; and
grant authorization to process the monetary transfer in response to the one or more specified actions being completed by the one or more named third parties.

13. The computer program product of claim 12, wherein the monetary transfer is one of: a card payment and an electronic fund transfer.

14. The computer program product of claim 12, wherein the distributing, completing and granting operations are performed using secure transactions on a computer network.

15. The computer program product of claim 14, wherein the computer network is one of: the Internet and an intranet.

16. The computer program product of claim 12, wherein each of the one or more named third parties is identified by one of: a username, and an email address.

17. The computer program product of claim 12, wherein the one or more specified actions include one of: directly granting an authorization to process a monetary transfer, and indirectly granting an authorization to process a monetary transfer.

18. The computer program product of claim 17, wherein the authorization to process a monetary transfer relates to instances of a same product or service as the initial contingent authorization

19. The computer program product of claim 18, wherein the instances of the product or service purchased by all parties is to be delivered at the same time and place.

20. The computer program product of claim 12, wherein the purpose of specifying the one or more actions in the proposal is to ensure co-participation in buying instances of a product or service.

21. The computer program product of claim 18, wherein the instances of the product or service relate to the leisure and/or travel sectors.

22. The computer program product of claim 12, wherein granting authorization includes granting authorization to a third party agent acting on behalf of the entity ultimately fulfilling the product or service being purchased by the authorizing party.

23. A system for granting authorization to conduct a monetary transfer, the system comprising:
a processor, the processor executing a computer program comprising instructions for:
creating a proposal, the proposal specifying one or more named third parties, one or more specified actions, and a time frame in which the one or more specified actions is to be completed;
distributing the proposal to the one or more named third parties;
completing the one or more specified actions by each of the one or more named third parties within the time frame specified in the proposal; and
granting authorization to process the monetary transfer in response to the one or more specified actions being completed by the one or more named third parties.
